(19) United States
(12) Patent Application Publication
(10) Pub. No.: US 2007/0259122 A1
(43) Pub. Date: Nov. 8, 2007

(54) METHOD FOR FORMING MULTI-LAYERED CERAMIC CHIP AND MULTI-LAYERED CERAMIC CAPACITOR

(76) Inventor: Yu-Seon Shin, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/744,149

(22) Filed: May 3, 2007

Related U.S. Application Data
(63) Continuation of application No. PCT/KR05/03674, filed on Nov. 3, 2005.

(30) Foreign Application Priority Data
Nov. 3, 2004 (KR) 10-2004-0088758

(51) Int. Cl. B05D 1/36

(52) U.S. Cl. 427/402

(57) ABSTRACT

Disclosed is a method for forming a multi-layered ceramic chip and a multi-layered ceramic capacitor with high accuracy, mass storage capability and high reliability by forming a thin dielectric layer with spin coating of curable slurry. This method is to produce a multi-layered ceramic chip using ceramic slurry. The method includes: forming said ceramic slurry and metal paste; forming a first ceramic layer by applying said ceramic slurry with a predetermined application process; curing said first ceramic layer; forming an internal electrode on the cured first ceramic layer; forming the second ceramic layer by applying said ceramic slurry onto the first ceramic layer into which the internal electrode is printed; curing said second ceramic layer; and repeating the last three procedures until the layer's numbers of said first ceramic layer and second ceramic layer arrive the predetermined height.

### CROSS-REFERENCE TO RELATED APPLICATIONS

This application is a continuation application under 35 U.S.C. §365(c) of International Application No. PCT/KR2005/003674, filed Nov. 3, 2005, designating the United States, which claims the benefit of Korean Patent Application No. 10-2004-0088758 filed Nov. 3, 2004. The International Application No. PCT/KR2005/003674 was published in English as WO 2006/049429 on May 11, 2006. This application incorporates herein by reference the International Application No. PCT/KR2005/003674, International Publication No. WO 2006/049429 and the Korean Patent Application No. 10-2004-0088758 in their entirety.

### BACKGROUND

1. Field of the Invention

The invention relates to a method for forming multi-layered chip and multi-layered ceramic capacitor; and, more particularly, to a method for forming multi-layered ceramic chip and multi-layered ceramic capacitor to form a ceramic dielectric using a wet-forming method.

2. Discussion of Related Technology

Recently, as the electronic and communication fields such as mobile telephone and satellite broadcasting are developed rapidly, the demands for mass storage capability and miniaturization are increased. To meet the demands, manufacturers of the electronic and communication equipments have made efforts for making the electronic components for them to be miniaturized, highly densified and stacked.

A Multi Layer Ceramic Capacitor (MLCC) has been developed and used as a representative multi-layered component. Such multi layered ceramic capacitor works in DC signal cut-off, bypassing and frequency resonance, and the demands for it are increasing.

FIG. 11 is a view showing the forming procedures of multi layered ceramic capacitor in order according to the prior art described in Korean Patent No. 0449623 entitled “Method for fabricating multi layered ceramic capacitor”, and FIG. 12 is a sectional view of the multi layered ceramic chip fabricated by the forming procedures in FIG. 11.

Referring to FIG. 11, the forming procedures according to the prior art is performed by initiating; preparing dielectric powder as the ceramic material powder prepared (S100); adding binder, plasticizer, or organic solvent to the dielectric powder; and Ball Milling it to make ceramic slurry.

Next, the ceramic slurry made is to be tape casted on an organic film (S104) to form ceramic green sheet thereon of a few tens of mm to a few hundreds of mm in thickness by using Doctor Blade method.

Next, an internal electrode is printed on the ceramic green sheet (S106), and after it is stacked into several layers with removing the organic film (S108), it is laminated in predetermined pressure to form a stacked sheet (S110). Finally, a compressed sheet is cut to fabricate a chip (S112).

A chip fabricated in this way is burn-out at the predetermined pressure and predetermined atmosphere (S114) and sintered (S116). An external electrode is formed on the chip by using termination method (S118), and the chip is sintered and plated (S120) to fabricate a capacitor.

As shown in FIG. 12, the internal electrode (140) is formed in a staggering way and a number of the ceramic green sheets are stacked on state of surrounding the internal electrode to fabricate a ceramic body (130).

According to the multi layered ceramic capacitor forming method under the this prior art, since sheets have to be handled individually in stacking the printed green sheets, in case that the thickness of dielectric is decreased to a few tens of mm, the strength of the green sheet is lowered to cause the sheet to be broken. Therefore, there arise a difficult problem in decreasing the thickness of dielectric.

In addition, since capabilities of the fabricating installments need to be increased to handle the printed green sheets, the fabricating procedures become complicated, and thereby increase the cost and decrease production efficiencies.

Further, since an internal electrode pattern is printed on a surface of the ceramic green sheet used for forming a multi-layered ceramic capacitor and depth difference occurs between the areas on which the internal electrode pattern is printed and not, if a number of ceramic sheets on which the internal electrode pattern is printed are stacked and compressed, remaining strain is produced due to the depth difference therebetween and a crack occurs due to local difference of partial plastic movement of ceramic layer in stacking. These drawbacks become more serious if more layers are stacked and mass storage capabilities are demanded.

The foregoing discussion of the related technology is to provide background information and does not constitute an admission of prior art.

### SUMMARY

One aspect of the invention is to provide a method of forming a multi-layered ceramic chip and a multi-layered ceramic capacitor which have high accuracy in thickness, mass storage capability, and high reliability by repeating steps of wet-forming a thin dielectric layer using curable slurry with spin coating method and forming internal electrode about the dielectric layer.

Another aspect of the invention is to provide a method of forming a multi-layered ceramic chip and a multi-layered ceramic capacitor, by which not only the yield is high and manufacturing cost is low since the manufacturing processes are simple and the processing time is decreased, but also the productivity is increased.

Another aspect of the invention is to provide a method of forming a multi-layered ceramic chip and a multi-layered ceramic capacitor in which the miniature structures are uniformly formed, and the thicknesses of dielectric body and internal electrode are controlled easily.

Another aspect of the invention is to provide a method of forming a multi-layered ceramic chip and a multi-layered ceramic capacitor in which the thickness of dielectric body is uniform, and the electrical features are produced uniformly reducing the electrical distortion.

In one embodiment, the method of forming a multi-layered ceramic chip comprises:
a-1) forming said ceramic slurry and metal paste;
a-2) forming a first ceramic layer by applying said ceramic slurry with a predetermined application process;
a-3) curing said first ceramic layer;
a-4) forming an internal electrode on the cured first ceramic layer;
a-5) forming the second ceramic layer by applying said ceramic slurry onto the first ceramic layer into which the internal electrode is printed;
a-6) curing said second ceramic layer; and
a-7) repeating a-4) to a-6) until the layers of said first ceramic layer and second ceramic layer reach the predetermined height.

In another embodiment the method comprises:
b-1) forming said ceramic slurry;
b-2) forming a first ceramic layer by applying said ceramic slurry with a predetermined application process;
b-3) printing an internal electrode on said first ceramic layer;
b-4) forming the second ceramic layer by applying said ceramic slurry onto the first ceramic layer into which the internal electrode is printed;
b-5) repeating b-3) to b-4) to form a ceramic chip until the layer's numbers of said first ceramic layer and second ceramic layer arrive the predetermined height;
b-6) cutting said ceramic chip and plasticizing and sintering; and
b-7) plating a external electrode of the ceramic chip.

As described above, in forming said multi-layered chip and multi-layered ceramic capacitor, the curable ceramic slurry is used, the thickness of them is easily controlled, the ceramic body is formed by stacking the ceramic slurry layer in order, and thereby it enables to fabricate the mass storage multi-layered ceramic capacitor.

In addition, in forming said multi-layered chip and multi-layered ceramic capacitor, the ceramic layers are stacked in order by using the spin-coating method, the internal electrode is formed as thin metal film, the ceramic body is laminated uniformly and thereby uniform electric features are obtained which reduce the electrical distortion.

Additionally, the procedures of the ceramic layer's application, the curing and the printing are repeated to form the multi-layered ceramic chip, such that the processes are so simple and easily performed that it can decrease the processing time and thereby increase the yield and productivity.

Additional advantages, objectives, and features of the invention will be set forth in part in the description which follows and in part will become apparent to those having ordinary skill in the art upon examination of the following or may be learned from practice with the invention. The objective and other advantages of the invention may be realized and attained by the structure particularly pointed out in the written description and claims as well as the appended drawings.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a diagram showing procedures in order for forming a multi-layered ceramic capacitor according to an embodiment of the invention;

FIG. 2-9 are views showing procedures for forming multi-layered ceramic chip according to an embodiment of the invention;

FIG. 10 is a sectional view a fabricated multi-layered ceramic chip;

FIG. 11 is a diagram showing procedures for forming a multi-layered ceramic capacitor according to the prior art; and

FIG. 12 is a sectional view showing a fabricated multi-layered ceramic chip according to the prior art.

### DETAILED DESCRIPTION OF EMBODIMENTS

Certain embodiments of the invention will be described in detail referring to the accompanying drawings as followings.

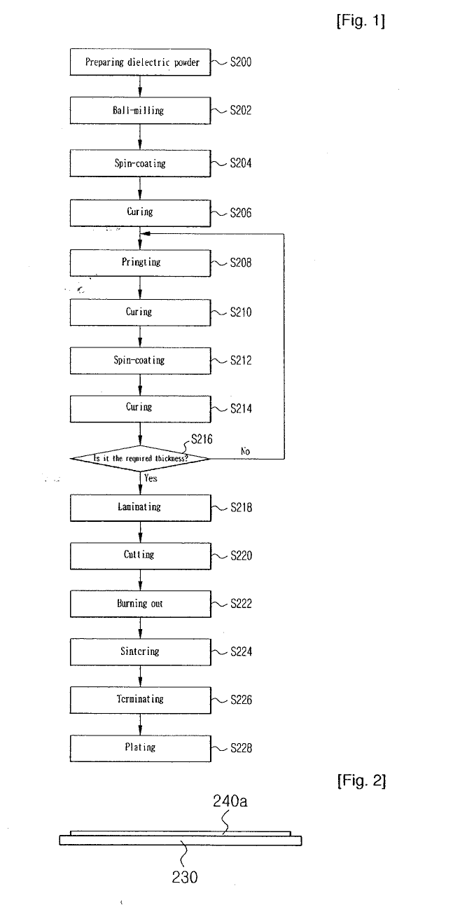

FIG. 1 is a diagram showing procedures in order for forming a multi-layered ceramic capacitor according to one embodiment of the invention.

Referring to FIG. 1, dielectric powder is prepared as ceramic material powder (S200). The dielectric powder is well known to the person who has ordinary skill in the art.

Next, slurry on which ceramic powder is dispersed uniformly within the organic is formed by wet mixing monomer and oligomer which are curable under the specific condition of ultraviolet radiation and heat, and polymerization initiator and dispersant with the dielectric powder prepared above. Metal electrode paste used as the internal electrode is formed by adding a predetermined amount of solvent, plasticizer or surface active agent into said slurry.

Said monomer includes single functional group or multi-functional group selected from acrylate group, styrene group and vinyl pyridine group. For example, any one selected from Ethyleneglycol diacrylate, Ethyleneglycol dimethacrylate, Diethyleneglycol diacrylate, Methyleneglycol bisacrylate, Propylene diacrylate, Trimethylolpr opane triacrylate, Trimethylolpropane trimethacrylate, Penthaerythtrtol tetraac rylate, Penthaerythtrtol trimethacrylate, Dipenthaerythtrtol hexaacrylate, Dipenthaerythtrtol hexamethacrylate, 1,2,4-butannetriol triacrylate, 1,4-benzenediol diacrylate and Triprophylenglycol diacryalte.

Said oligomer includes at least one selected from Uretane acrylate, Epoxy acrylate, Polyester acrylate, Polyethylene glycol bisacrylate, Polyproylene glycol bismethacrylate and spirane acrylate.

Said polymerization initiator includes polyerrization which cause a radical polymerization reaction. For example, it includes at least one selected from 2,2-dimethoxy-2-phenyl acetophenone, 1-hydroxy-cyclohexyl-phenylketone, para-phenylbenzo phenone, Benzyldimethylketal, 2,4-dim ethylthioxanthone, 2,4-diethylthioxanthone, Benzoin ethyl ether, Benzoin isobutyl ether, 4,4-diethylaminobenzophenone and para-dimethylamino benzoic acid ethylester.

A predetermined amount of polymer binder is added to said ceramic slurry due to demand for viscosity control.

The viscosity of said ceramic slurry can be changed from low viscosity of a few tens cps to high viscosity of a few hundreds cps depending on process requirement.

In addition, said metal electrode paste is formed by adding a small amount of monomer and oligomer which are curable under the specific condition of ultraviolet radiation and heat, and polymerization initiator, dispersant, plasticizer and solvent to metal powder, such as those of Ag, Ag—Pd, Cu or Ni.

Next, a ceramic layer of predetermined thickness is formed by coating said ceramic slurry by using predetermined application method (S204). A representative application method refers to a spin coating method. Because the spin coating method comprises steps of dropping a predetermined amount of ceramic slurry to the center of rotation plate which is rotating and applying ceramic slurry to the basic material to uniform thickness by using centrifugal force of the rotation plate and viscosity of the slurry itself, the thickness of the first ceramic layer can be controlled by controlling the viscosity of ceramic slurry and the rotation speed of the rotation plate. Except for the spin coating method, a screen printing method, a offset printing method, or a gravure offset printing method can be included.

Following, the internal electrode is printed on said cured ceramic layer (S208). Said internal may be printed by using process of screen printing method, offset printing method, gravure offset printing method, or photolithographing and developing after application. The process of curing the internal electrode can be performed.

Subsequently, the internal electrode layer is cured secondly (S210). The second curing process may be preformed as same as the first curing method, but not excluding the curing process disclosed in the art, such as curing process by drying. For all that, to shorten the processing time, instead of curing process by drying, the curing process as same as the first curing process is preferable. A curing process by UV is more preferable, and curing processes by well-known technology can be accepted.

Next, the processes of applying, first curing, internal electrode printing and second curing are repeated until gaining the required layers of ceramic layer.

Subsequently, if the thickness of ceramic layers becomes to the required level (S212), a stacked sheet is formed by laminating the stacked ceramic layers at predetermined pressure (S214). In the embodiment of the invention, the laminating process may be omitted depending on the forming density of ceramic formed and internal electrode printed.

Following, after the multi-layered ceramic chip is formed by cutting said laminated multi-layered sheet (S216), the multi-layered chip is organic burn-out at predetermined pressure and temperature (S218).

Said organic burn-out process may be performed at 30 C to 800 C. Subsequently, after applying the external electrode to said multi-layered ceramic chip, the multi-layered ceramic capacitor according to the embodiment of the invention is fabricated through the general steps of Sintering (S220), Termination (S222) and Plating (S224).

FIG. 2-9 are views showing procedures in order for forming multi-layered ceramic chip according to embodiments of the invention, and FIG. 10 is a sectional view a fabricated multi-layered ceramic chip according to the embodiments of the invention.

Referring to FIG. 2, first, the ceramic slurry is applied uniformly on the rotation plate by predetermined method, which is fabricated by wet mixing monomer and oligomer which are curable under the specific condition of ultraviolet radiation and heat, and polymerization initiator and dispersant with the dielectric powder of material powder. As a result, the first ceramic layer of (240a) a predetermined thickness is formed on the rotation plate (230). A predetermined amount of solvent, plasticizer or surface active agent may be added to said slurry.

Said slurry is preferably formed with viscosities of which is controllable from the high to the low to make multi-layered ceramic to be controlled, and the thickness of the first ceramic layer is controlled by changing the viscosity of the slurry and the speed of the rotation plate.

The thickness of said first ceramic layer (240a) is preferably about 1 mm, however, it is not limited to this embodiment, but changed contingent on the requirement of installment capacity.

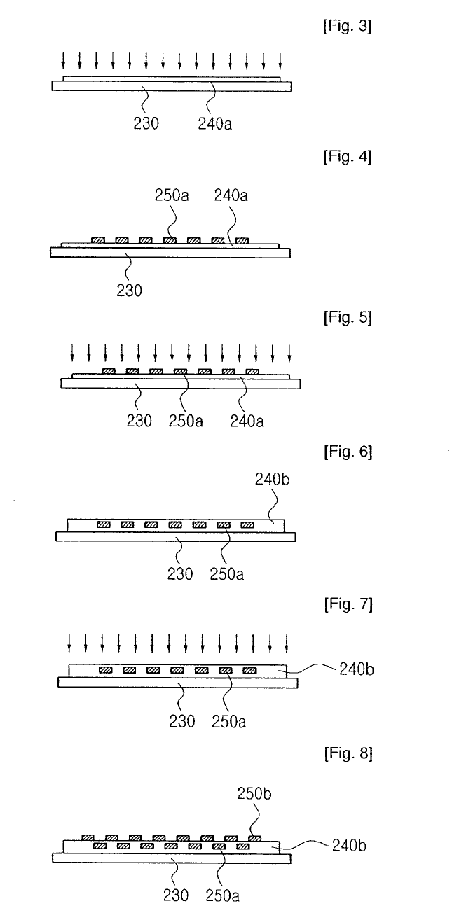

Referring to FIG. 3, the first ceramic layer formed above is first cured. The first curing process is performed by using UV, including the prior well known method.

Referring to FIG. 4, subsequently, an internal electrode (250a) is formed in said cured first ceramic layer. Said internal electrode is formed by using process of screen printing method, offset printing method, gravure offset printing method, electrode material application, photolithography, or developing after application of metal film used as an internal electrode.

Said metal film is formed by using metal material of Ag, Ag—Pd. To decrease cost in manufacturing a mass storage multi-layered chip, the material of Cu, Ni may be used. In addition, said internal electrode is fabricated by using metal paste which is formed by adding monomer and oligomer which are curable under the specific condition of ultraviolet radiation and heat, and polymerization initiator, dispersant and solvent to metal powder of Ag, Ag—Pd, Cu or Ni material.

Referring to FIG. 5, said internal electrode (250a) layer is second cured. As similar to the first curing, the second curing process is performed by using UV, including the prior well known method.

Referring to FIG. 6, the second ceramic layer (240b) of predetermined thickness is formed by spin-coating slurry onto the first ceramic layer (240a) into which said internal electrode (250a) is printed.

Referring to FIG. 7, said second ceramic layer is cured.

Referring to FIG. 8, an internal electrode is printed on said cured second ceramic layer.

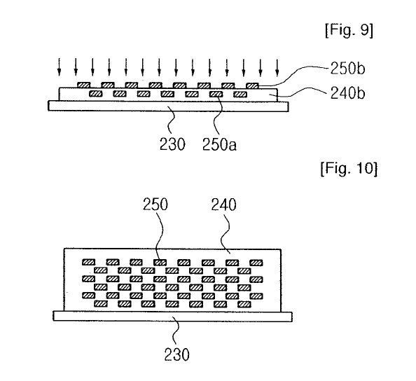

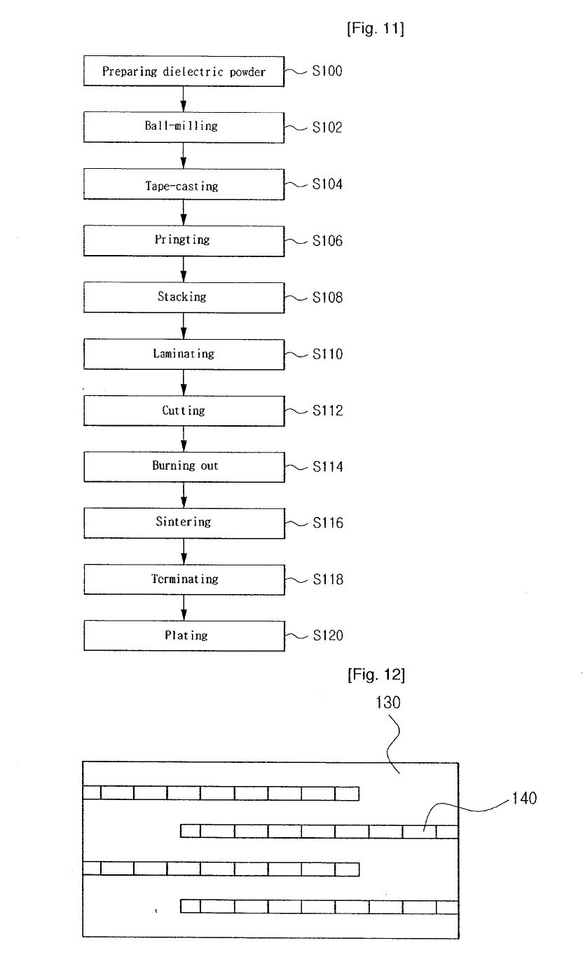

Referring to FIG. 9, said internal is second cured. Subsequently, until meeting the requirements of design level by repeating the procedures described in FIGS. 4-7, the procedures of said ceramic layer application, internal electrode printing, the second curing, ceramic layer application and the first curing are repeated to form finally the ceramic chip.

The ceramic layers formed by the above procedures have a thickness of no more than 1 mm with less thickness variation compared with those formed by the prior tape-casting method or coating method.

As shown in FIG. 10, a ceramic layer (240) is stacked in order, and a ceramic chip is formed in which an internal electrode (250) is formed between stacked ceramic layers according to the embodiment of the invention.

As described above in detail, under the multi-layered ceramic chip and method for forming multi-layered ceramic capacitor according to embodiments of the invention, in forming said multi-layered chip and multi-layered ceramic capacitor, the curable ceramic slurry and the metal electrode paste are used, the thickness of them is easily controlled, and the ceramic body consisting of multi-layered ceramics, of a few tens mm to a few hundreds mm in thickness is formed by stacking the ceramic slurry layer and the metal electrode layer in order with spin coating method which enables thin forming to fabricate the mass storage multi-layered ceramic capacitor.

In that in forming said multi-layered chip and multi-layered ceramic capacitor, the ceramic layers are stacked in order by using the spin-coating method, the internal electrode is formed as thin metal film, and the ceramic body is laminated uniformly and thereby uniform electric features are obtained which reduce the electrical distortion.

Additionally, according to the embodiment of the invention, the procedures of the ceramic layer's application, the curing and the printing are repeated to form the multi-layered ceramic chip. Therefore, the processes are so simple and easily performed that it can decrease the processing time and thereby increase the yield and productivity.

It will be apparent to those skilled in the art that various modifications and variations can be made in the invention of the multi-layered ceramic and the method for forming the multi-layered ceramic capacitor, not limited to the embodiments described above. Thus, it is intended that the invention covers the modifications and variations of this invention provided they come within the scope of the appended claims and their equivalents.

For example, said the viscosity of the ceramic slurry, the thickness of the application and the ceramic body can be changed depending to the design.

What is claimed is:

1. A method of forming a multi-layered ceramic chip, said method comprising:
providing a ceramic slurry and a metal paste;
forming a first ceramic layer using said ceramic slurry;
curing said first ceramic layer;
forming an internal electrode over the cured first ceramic layer;
forming a second ceramic layer using ceramic slurry over the internal electrode; and
curing said second ceramic layer.

2. The method of claim 1 further comprising repeating the sequence of forming an internal electrode, forming a second ceramic layer, and curing the second ceramic layer until the stack of the first ceramic layer, the internal electrode(s) and the second ceramic layer(s) reaches a predetermined thickness.

3. The method of claim 1, wherein said method further comprises curing said internal electrode after forming thereof.

4. The method of claim 1, wherein providing said ceramic slurry comprises mixing components of the slurry using at least one device selected from the group consisting of a ball mill, a planetary mill, a beads mill, an atomizer and a jet mill.

5. The method of claim 1, wherein each of the first and second ceramic layers has a thickness of about 1 mm or less.

6. The method of claim 1, wherein forming the first ceramic layer uses a method selected from the group consisting of a spin coating method, a screen printing method, a offset printing method, and a gravure offset printing method.

7. The method of claim 1, wherein said internal electrode is formed using a method selected from the group consisting of a spin coating method, a screen printing method, offset printing method and a gravure offset printing method, or coating, photolithographing and developing.

8. The method of claim 1, wherein said internal electrode is formed using at least one metallic material selected from the group consisting of materials containing Ag, Ag—Pd, Cu and Ni.

9. The method of claim 1, wherein said method, after curing the second ceramic layer, further comprises cutting the resulting stack into a plurality of laminated ceramic chips.

10. The method of claim 9, further comprising plating an external electrode on at least one of the plurality of laminated ceramic chips.

11. The method of claim 1, wherein said ceramic slurry comprises a curable monomer, an oligomer, a polymerization initiator and dispersant.

12. The method of claim 1, wherein said ceramic slurry further comprises at least one of a polymer binder, a solvent and a surface active agent.

13. The method of claim 11, wherein said monomer comprises one or more substituent groups selected from the group consisting of an acrylate group, a styrene group and a vinyl pyridine group.

14. The method of claim 11, wherein said oligomer comprises at least one selected from the group consisting of uretane acrylate, epoxy acrylate, polyester acrylate, polyethylene glycol bisacrylate, polyproylene glycol bismethacrylate and spirane acrylate.

15. The method of claim 11, wherein said polymerization initiator is configured to initiate a radical polymerization reaction upon application of UV or heat.

16. The method of claim 1, wherein the internal electrode is formed using a printing method.

17. The method of claim 11, wherein said monomer comprises at least one selected from the group consisting of ethyleneglycol diacrylate, ethyleneglycol dimethacrylate, diethyleneglycol diacrylate, methyleneglycol bisacrylate, propylene diacrylate, trimethylolpr opane triacrylate, trimethylolpropane trimethacrylate, penthaerythtrtol tetraac rylate, penthaerythtrtol trimethacrylate, dipenthaerythtrtol hexaacrylate, dipenthaerythtrtol hexamethacrylate, 1,2,4-butannetriol triacrylate, 1,4-benzenediol diacrylate and triprophylenglycol diacryalte.

18. The method of claim 11, wherein said polymerization initiator is configured to initiate a radical polymerization reaction, and is selected from the group consisting of 2,2-dimethoxy-2-phenyl acetophenone, 1-hydroxy-cyclohexyl-phenylketone, para-phenylbenzo phenone, benzyldimethylketal, 2,4-dim ethylthioxanthone, 2,4-diethylthioxanthone, benzoin ethyl ether, benzoin isobutyl ether, 4,4-diethylaminobenzophenone and para-dimethylamino benzoic acid ethylester.

19. A method of making a capacitor, comprising the method of claim 1.

20. A method of making a capacitor, comprising the method of claim 10.
